(19) United States
(12) Patent Application Publication
(10) Pub. No.: US 2005/0220984 A1
(43) Pub. Date: Oct. 6, 2005

(54) Method and system for control of processing conditions in plasma processing systems

(75) Inventors: Sheng Sun, Fremont, CA (US); Cecilia Mak, San Jose, CA (US); Kam Law, Union City, CA (US)

Correspondence Address: Patent Counsel;Applied Materials, Inc., Legal Affairs Department, M/S 2061, P.O. Box 450A, Santa Clara, CA, 95052, US

(73) Assignee: APPLIED MATERIALS INC., A Delaware corporation, Santa Clara, CA (US)

(21) Appl. No.: 10/817,611

(22) Filed: Apr. 2, 2004

(51) Int. Cl. B05D 1/00

(52) U.S. Cl. 427/8; 427/163.2; 427/255.28; 118/723 R; 156/345.24

(57) ABSTRACT

Methods and systems are provided for processing a film over a substrate in a process chamber using plasma deposition. A plasma is formed in the process chamber and a process gas mixture suitable for processing the film is flowed into the process chamber under a set of process conditions. The process gas mixture may include a silicon-containing gas and an oxygen-containing gas to deposit a silicate glass, which may in some instances also be doped to obtain specifically desired optical properties. A parameter is monitored during processing of the film so that the process conditions may be changed in accordance with a correlation among a value of the parameter, an optical property of the film, and the process conditions.

### BACKGROUND OF THE INVENTION

Much effort is currently being devoted to the development of optical networking systems as an alternative to electronic-based networks. In this emerging technology, pulses of light are used instead of currents of electrons to carry out such diverse networking functions as data transmission, data routing, and other forms of data communication and processing. Such functions are achieved with a number of discrete components, but integral to virtually all developing optical networking systems are optical-waveguide structures that are used to guide light being propagated from one location to another. For example, in one specific application that is being aggressively developed, optical waveguides are used to confine and carry optical signals in conformity with a dense wavelength division multiplexed (“DWDM”) protocol. Such a protocol increases the amount of information carried with individual optical signals by multiplexing discrete wavelength components, thereby increasing the effective bandwidth that may be accommodated with the optical networking system.

To illustrate the use of optical waveguides in such systems, FIG. 1A provides a cross-sectional view of a typical optical-fiber waveguide 100. The waveguide includes two principal components—a core 104 through which the light is propagated and a cladding layer that acts to confine the light. The cladding layer is shown comprising an uppercladding layer 102 and an undercladding layer 106 around the core 104. To ensure that the light is confined, the core 104 is usually surrounded completely by the cladding layer, which also generally has a lower refractive index (“RI”). The difference in refractive indices of the core 104 and cladding layer permits light to be confined by total internal reflection within the core 104. FIG. 1A illustrates the concept of total internal reflection with an exemplary light ray 108, with the confinement angle θ_{c}, representing an upper limit on angles at which the light can be incident on the core/cladding interface without leakage.

As more wavelength components are incorporated into optical-waveguide channels within DWDM systems, there is a corresponding increase in demand for optical components to perform routing, switching, add/drop, and other functions. A variety of photonic components have the capacity to perform such functions, including, for example, filters, modulators, amplifiers, couplers, multiplexers, cross connects, arrayed waveguide gratings, power splitters, star couplers, and others. As optical networking technology matures, however, one goal is to integrate various photonic components monolithically onto a single structure, such as a silicon-chip or glass substrate.

A number of efforts have been made at such development, but attempts to integrate optical waveguides and photonic components onto a single chip have faced significant challenges. Some approaches have attempted to modify techniques for monolithic integration of electronic components, but have encountered a variety of difficulties. These difficulties often arise from fundamental differences between photonic and electronic applications. For example, the scale of photonics applications is much greater than the scale for electronics applications, sometimes as much as 1-2 orders of magnitude. This difference in scale results in a need to deposit much thicker films in photonics applications, with films commonly having thicknesses of several to tens of microns.

One consequence of this increased thickness is much greater variations in uniformity of the structures. In addition, techniques for monolithic integration of electronic components have been sharply focused on optimizing the dielectric constant of materials because of its importance in electronic applications. In contrast, photonic applications are instead sensitive to optical characteristics of materials, such as its refractive index and birefringence. For a typical waveguide made with SiO₂ films, the core and cladding layers may have refractive indices that differ by less than 1%; sometimes product specifications use five digits of significance to define the required refractive index. It has often been found that the methods and materials used for producing structures in electronic applications simply do not meet the optical requirements of photonic applications.

One prior-art technique that has been widely used in producing optical waveguides is flame hydrolysis. This technique is not only very costly, but has, in practice with large substrates, been found to produce structures with poor uniformity. Other techniques have been used in attempts at mitigating thermal strain by separately depositing a lower cladding layer, over which optical cores are formed, and subsequently depositing an upper cladding layer over and between the optical cores. One specific technique that has been used in such efforts is plasma-enhanced chemical-vapor deposition (“PECVD”). An example of an optical-waveguide structure formed using PECVD is shown in FIG. 1B.

The cross sectional view of the structure 110 provided in FIG. 1B shows three optical cores 104, thereby corresponding to three optical waveguides 100. Light is intended to travel through each optical core 104 in a direction orthogonal to the page. The optical cores 104 are formed over the undercladding layer 106, which is itself formed over a substrate 112. The uppercladding layer 102 has been deposited with PECVD. Use of PECVD techniques is known to produce films having significant levels of hydrogen impurities, which leads to undesirable nonuniformities in refractive index in the cladding layers. The negative effect of such nonuniformities is further exacerbated by the nonconformal nature of PECVD deposition since portions of the cladding layer may be very thin near parts of each core. These features may interfere with optical transmission and permit unsatisfactory propagation losses.

There is accordingly a persistent need for improved methods and systems for manufacturing optical waveguides that meet stringent refractive-index requirements, are resistant to cracking, and are amenable to efficient use in production environments.

### BRIEF SUMMARY OF THE INVENTION

These criteria are met in different embodiments of the invention by incorporating a monitoring device within a process chamber for monitoring one or more parameters during processing of films, such as during fabrication of an optical waveguide. The information collected by the monitoring device is used in a feedback arrangement to adjust process conditions and thereby achieve the desired optical properties of the films as they are deposited. The feedback arrangement generally relies on previously determined correlations among the parameters measured with the monitoring device, the desired optical characteristics, and the process conditions. Such correlations may be managed by a trained evaluation system that has self-correcting capabilities so that accumulation of additional data improves its performance, such as implemented with an expert system or neural network. The feedback arrangement permits the formation of stepped-index optical waveguides with narrowly constrained refractive-index properties for the core and cladding, or permits the formation of graded-index optical waveguides in which the core has a refractive index that varies in a precisely controlled manner.

Thus, in one embodiment, a method is provided for processing a film over a substrate in a process chamber. A plasma is formed in the process chamber and a process gas suitable for processing the film is flowed into the process chamber in accordance with a predetermined algorithm specifying process conditions. The process gas may include a silicon-containing gas and an oxygen-containing gas to deposit a silicate glass, which may in some instances also be doped to obtain specifically desired optical properties. The predetermined algorithm may be optimized to control a vertical profile of the film, or in some embodiments may be optimized to control a horizontal profile of the film. A parameter is monitored during processing of the film over a thickness greater than 3 μm so that the process conditions may be changed in accordance with a correlation among a value of the parameter, an optical property of the film, and the process conditions. Such changes may be effected by the trained evaluation system. The parameter may comprise a process parameter, such as one related to plasma diagnostics, or may comprise a film-property parameter, such as may determined with a reflectometry or ellipsometry measurement. In one embodiment, the parameter comprises a stress of the film. In another embodiment, the parameter comprises a uniformity of the film.

The methods of the present invention may be embodied in a thick-film processing system having a process chamber, a plasma-generating system, a substrate holder, a gas-delivery system, pressure-control system, a sensor, and a controller. A memory is coupled with the controller and includes a computer-readable storage medium having a computer-readable program embodied therein for directing operation of the thick-film processing system in accordance with the embodiments described above.

### BRIEF DESCRIPTION OF THE DRAWINGS

A further understanding of the nature and advantages of the present invention may be realized by reference to the remaining portions of the specification and the drawings.

FIG. 1A is an internal view of an optical-fiber waveguide illustrating the principle of total internal reflection;

FIG. 1B is a cross-sectional view of an optical waveguide structure made using PECVD to form the cladding layers;

FIG. 2 is a schematic overview of a system in accordance with an embodiment of the invention;

FIG. 3 shows an illustrative block diagram of the hierarchical control structure of software for controlling apparatus according to a specific embodiment;

FIG. 4 provides a flow diagram summarizing certain embodiments of the invention for processing a film;

FIG. 5 presents PECVD deposition results illustrating the effect on the refractive index of silicon oxide films as they are deposited;

FIGS. 6A-6C present PECVD deposition results illustrating the effect of deposition time deposition rate, refractive index, and stress; and

FIGS. 7A-7C present PECVD deposition results illustrating the effect of power stepping on the deposition rate, refractive index, and stress in accordance with an embodiment of the invention.

### DETAILED DESCRIPTION OF THE INVENTION

Embodiments of the invention permit the deposition of thick films over a substrate in a process chamber while maintaining strict control over one or more optical properties as the films are being deposited. As used herein, a “thick” film has a thickness greater than 3 μm and, as such, is 1-2 orders of magnitude thicker in the photonics applications described herein than is used in electronics applications. In some embodiments, the films are deposited with thicknesses greater than 5 μm. Embodiments of the invention permit not only providing careful control of optical properties in the vertical direction as the film is deposited, but also in the horizontal direction across the wafer surface. Such characteristics are useful, for example, in controlling the two-dimensional uniformity of the refractive index for the wafer. Such two-dimensional control is also provided in embodiments of the invention to ensure uniformity in global thickness, dopant-concentration uniformity, and stress uniformity, all of which may be controlled more precisely than in electronics applications.

This control may be achieved according to embodiments of the invention by using one or more of the following mechanisms. First, embodiments of the invention may begin with a predetermined algorithm that is structured to control the vertical profile of a film. Second, in situ monitoring and feedback of process conditions and/or film properties may be used to modify the algorithm to provide for more precise control over such properties. In some instances, a neural-network learning algorithm may be included in defining such feedback, although other types of artificial-intelligence techniques may alternatively be used.

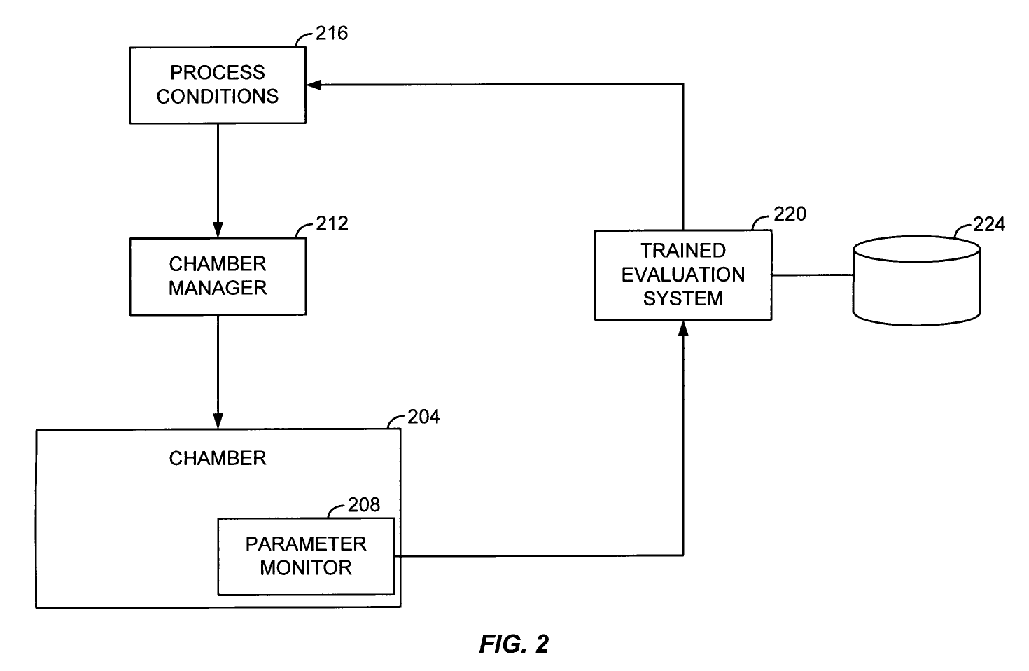

These mechanisms are implemented in embodiments of the invention with a trained evaluation system that is integrated with the processing apparatus, as indicated schematically in FIG. 2. As also shown in FIG. 2, a chamber manager 212 is used to control the operation of a process chamber 204 in accordance with specified process conditions 216. The process conditions 216 are sufficient to define how deposition of the film within the process chamber 204 is effected. For example, in an embodiment where a PECVD method is used for deposition, the process conditions 216 may specify the flow rates of precursor gases into the process chamber 204, the RF power for generating a plasma, and the temperatures maintained by chamber and/or substrate heating systems, in addition to other possible process conditions. For purposes of illustration, the following discussion sometimes makes reference to deposition of a film, although it should be appreciated that embodiments of the invention may also apply to other processes that may be used for photonics and optical applications, including etching, annealing, and the like.

Initial deposition of a film may proceed with the predetermined algorithm to control the vertical profile. Then, as the film is being deposited, the value of a parameter that may be correlated with an optical property of the film and the process conditions 216 is monitored with a parameter monitoring device 208, which may be included within the process chamber 204. In some embodiments, the parameter monitoring device 208 may comprise a device that measures a property of the film, such as a reflectometer or ellipsometer. In other embodiments, the parameter monitoring device 208 may comprise a plasma-diagnostics system to measure RF match output parameters, such as RF impedance, load and tune capacitance, RF current, peak-to-peak voltage, DC bias voltage, etc. The correlation between the value of the parameter, the optical property of the film, and the process conditions is drawn with the trained evaluation system 220, which may rely on data stored in a knowledge database 224 for making the correlation. For example, the trained evaluation system 220 may comprise an expert system or neural network that has been prepared to evaluate the monitored parameter, to determine what the value of the monitored parameter should be to achieve the desired optical property of the film, and to determine how to modify the process conditions to achieve or maintain the appropriate value of the monitored parameter. Such monitoring and evaluation may be performed throughout the deposition of the thick film, either periodically or continuously, to achieve very tight control over the optical properties of the fully deposited film.

Any of a variety of different types of CVD apparatus may be incorporated into embodiments of the invention. For instance, the CVD apparatus may comprise a PECVD apparatus configured for deposition of thick films, etching of thick films, annealing of thick films, and/or any other optical application. Examples of suitable processing chambers are described in detail in commonly assigned U.S. Pat. Nos. 5,558,717 and 5,853,607, the entire disclosures of which are incorporated herein by reference in their entireties.

To configure the apparatus for deposition of thick films, a number of modifications may be made when compared with similar CVD apparatus used for the deposition of relatively thin films. For example, the optical properties of thick films are known to be very sensitive at the edges of the substrate. It is accordingly desirable to expand the plasma in the horizontal direction across the substrate to improve uniformity in a number of aspects, such as thickness, dopant concentration, and stress. The substrate may be maintained in a process chamber on a pedestal with a clamping ring. In one embodiment, this configuration is flattened and extended horizontally in comparison with thin-film deposition configurations, allowing improvements in uniformity with resultant improvements in optical properties at the edges of the wafer.

Similarly, deposition of thick films tends to produce films that are loose at the substrate edges when configurations appropriate for thin-film deposition are used. This edge film quality results in the accumulation of loose byproducts, which reduce the pumping capability of the deposition system. The inventors have found that increasing an electrode gap opening used in generating the plasma results in improved film quality, particularly at the edges where the accumulation of loose byproducts is reduced. Accordingly, in some embodiments of the invention a PECVD apparatus is used with an extended and flattened pedestal and with an increased electrode gap opening, both of which improve the deposition of thick films. These approaches may also be extended to accommodate even larger deposition areas in some embodiments.

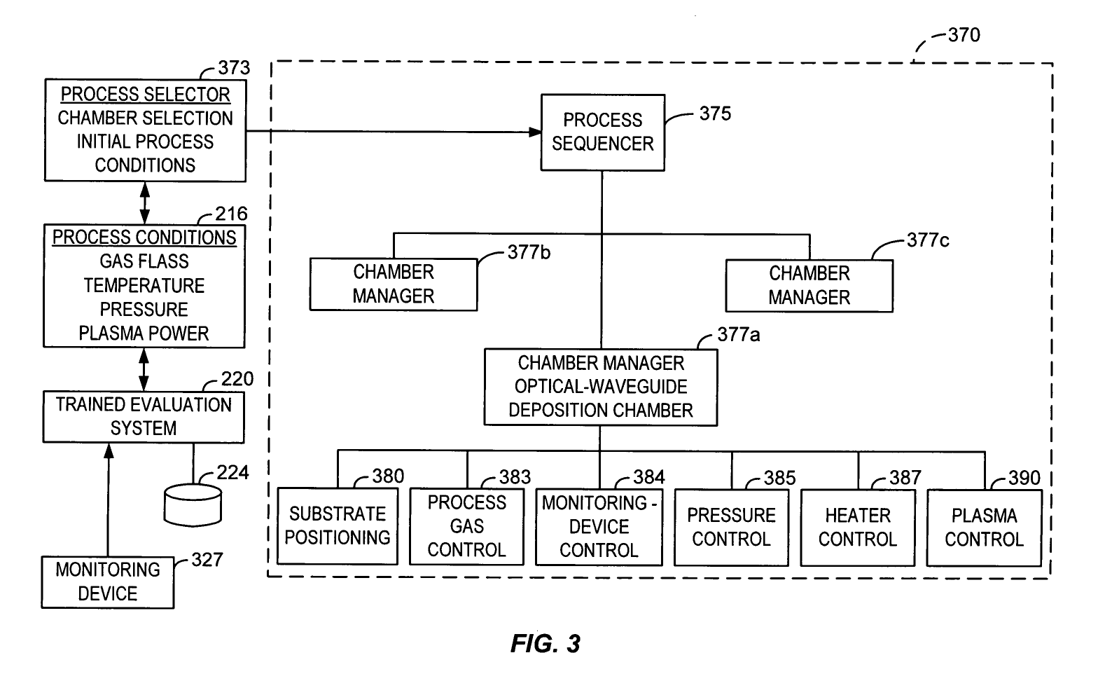

The processing of a film can be implemented using a computer program product that is executed by a controller that runs system control software, an exemplary structure for which is shown in FIG. 3. This figure includes an illustrative block diagram of the hierarchical control structure of the system control software, computer program 370, according to a specific embodiment. To implement a process, a user enters a process set number and process chamber number into a process selector subroutine 373 in response to menus. The process sets are predetermined sets of initial process conditions 216 for carrying out specified processes, and are identified by predefined set numbers.

Each process set includes a predetermined algorithm that acts to control the vertical profile of a film as it is processed. Also, as described in more detail below, these process conditions 216 may be modified interactively during the process with the trained evaluation system 220 to effect more precise control. The process selector subroutine 373 identifies (i) the desired process chamber and (ii) the desired process set of initial process conditions 216 for operating the process chamber to perform the desired process. The initial process conditions 216 of a given process set may comprise, for example, process gas composition and flow rates, temperature, pressure, plasma conditions such as RF power levels and the low frequency RF frequency, cooling gas pressure, and chamber wall temperature. These initial process conditions are provided to the user with a suitable interface.

A process sequencer subroutine 375 comprises program code for accepting the identified process chamber and set of initial process conditions from the process selector subroutine 373, and for controlling operation of the various process chambers. Multiple users can enter process set numbers and process chamber numbers, or a user can enter multiple process set numbers and process chamber numbers, so the sequencer subroutine 375 operates to schedule the selected processes in the desired sequence. Preferably, the sequencer subroutine 375 includes a program code to perform the steps of (i) monitoring the operation of the process chambers to determine if the chambers are being used, (ii) determining what processes are being carried out in the chambers being used, and (iii) executing the desired process based on availability of a process chamber and type of process to be carried out. Conventional methods of monitoring the process chambers can be used, such as polling. When scheduling which process is to be executed, sequencer subroutine 375 takes into consideration the present condition of the process chamber being used in comparison with the desired process conditions for a selected process, or the “age” of each particular user entered request, or any other relevant factor a system programmer desires to include for determining scheduling priorities.

Once the sequencer subroutine 375 determines which process chamber and process set combination is going to be executed next, the sequencer subroutine 375 initiates execution of the process set by passing the particular process set to a chamber manager subroutine 377a-c, which controls multiple processing tasks in a process chamber according to the process set determined by the sequencer subroutine 375. For example, the chamber manager subroutine 377a comprises program code for optical-waveguide deposition process operations in the process chamber. The chamber manager subroutine 377 also controls execution of various chamber component subroutines that control operation of the chamber components necessary to carry out the selected process set. Examples of chamber component subroutines are substrate positioning subroutine 380, process gas control subroutine 383, monitoring-device control subroutine 384, pressure control subroutine 385, heater control subroutine 387, and plasma control subroutine 390. Those having ordinary skill in the art will readily recognize that other chamber control subroutines can be included depending on what processes are to be performed in the process chamber.

In operation, the chamber manager subroutine 377a selectively schedules or calls the process component subroutines in accordance with the particular process set being executed. The chamber manager subroutine 377a schedules the process component subroutines much like the sequencer subroutine 375 schedules which process chamber and process set are to be executed next. Typically, the chamber manager subroutine 377a includes steps of monitoring the various chamber components, determining which components need to be operated based on the process parameters for the process set to be executed, and causing execution of a chamber component subroutine responsive to the monitoring and determining steps.

The chamber manager subroutine 377a also receives instructions from the trained evaluation system 220 to modify the process conditions. Such modifications are determined by the trained evaluation system 220 from data received by the monitoring device 327 to ensure that certain desired characteristics are achieved during processing. The instructions from the trained evaluation system 220 may provide continuous or periodic updates of the process conditions. The effect of the interaction between the trained evaluation system 220 and the chamber manager 377a results in a process that may individualize processing characteristics rather than strictly following a recipe. Each process begins by implementing the initial process conditions specified, but causes individualized variations in those process conditions for each implementation. These variations may be different every time the process is executed, inherently taking account of subtle differences in external parameters that may affect the process. A consequence of including such individualized variations through the process is greater uniformity in the results. Such improved uniformity may comprise improved uniformity in global thickness, improved dopant-concentration uniformity, improved stress uniformity, and the like, in different embodiments.

Operation of particular chamber component subroutines will now be described. The substrate positioning subroutine 380 comprises program code for controlling chamber components that are used to load the substrate at a desired height in the chamber. The process gas control subroutine 383 has program code for controlling process gas composition and flow rates. The process gas control subroutine 383 controls the open/close position of safety shut-off valves, and also ramps up/down mass flow controllers to obtain the desired gas flow rate. The process gas control subroutine 383 is invoked by the chamber manager subroutine 377a, as are all chamber component subroutines, and receives a specification of process conditions from the chamber manager subroutine defining the desired gas flow rates. Typically, the process gas control subroutine 383 operates by opening gas supply lines and repeatedly (i) reading the necessary mass flow controllers, (ii) comparing the readings to the desired flow rates received from the chamber manager subroutine 377a and perhaps modified by the trained evaluation system 216, and (iii) adjusting the flow rates of the gas supply lines as necessary. Furthermore, the process gas control subroutine 383 includes steps for monitoring the gas flow rates for unsafe rates and for activating the safety shut-off valves when an unsafe condition is detected.

In some processes, an inert gas such as helium or argon is flowed into the chamber to stabilize the pressure in the chamber before reactive process gases are introduced. For these processes, the process gas control subroutine 383 is programmed to include steps for flowing the inert gas into the chamber for an amount of time necessary to stabilize the pressure in the chamber, and then the steps described above would be carried out. Additionally, when a process gas is to be vaporized from a liquid precursor, for example, tetraethylorthosilane (“TEOS”), the process gas control subroutine 383 is written to include steps for bubbling a delivery gas, such as helium, through the liquid precursor in a bubbler assembly or introducing a carrier gas, such as helium or nitrogen, to a liquid injection system.

The monitoring-device control subroutine 384 comprises program code for controlling the monitoring device. The specific nature of the code may depend on what type of monitoring device is being controlled and, in some instances, the program code may include provisions for controlling a variety of different types of monitoring devices. If the monitoring device comprises a reflectometer, for example, the monitoring device functions by reflecting polychromatic light off the substrate and spectrally analyzing the reflected spectrum; accordingly, the program code specifies when measurements are to be taken and which light source is to be used if the reflectometer has multiple light sources. If the monitoring device comprises an ellipsometer, the device functions by reflecting monochromatic light off the substrate and permits calculation of the thickness of the substrate; the program code thus specifies when measurements are to be taken and the wavelength of the light to be used. In some cases, the monitoring device may comprise a combined ellipsometer/reflectometer, in which case the program code additionally coordinates whether to invoke the ellipsometry functions or the reflectometry functions.

The pressure control subroutine 385 comprises program code for controlling the pressure in the chamber by regulating the size of an opening of a throttle valve in an exhaust system of the chamber. The size of the opening of the throttle valve is set to control the chamber pressure to the desired level in relation to the total process gas flow, size of the process chamber, and pumping setpoint pressure for the exhaust system. When the pressure control subroutine 385 is invoked, the desired, or target, pressure level is received from the chamber manager subroutine 377a. The pressure control subroutine 385 operates to measure the pressure in the chamber by reading one or more conventional pressure manometers connected to the chamber, to compare the measure value(s) to the target pressure, to obtain PID (proportional, integral, and differential) values from a stored pressure table corresponding to the target pressure, and to adjust the throttle valve according to the PID values obtained from the pressure table. Alternatively, the pressure control subroutine 385 can be written to open or close the throttle valve to a particular opening size to regulate the chamber to the desired pressure. Changes in pressure during the process may be made in accordance with instructions received from the trained evaluation system 216.

The heater control subroutine 387 comprises program code for controlling the current to a heating unit that is used to heat the substrate 320. The heater control subroutine 387 is also invoked by the chamber manager subroutine 377a and receives a target, or set-point, temperature parameter. The heater control subroutine 387 measures the temperature by measuring voltage output of a thermocouple located in a pedestal that supports the substrate within the process chamber, comparing the measured temperature to the set-point temperature, and increasing or decreasing current applied to the heating unit to obtain the set-point temperature. The temperature is obtained from the measured voltage by looking up the corresponding temperature in a stored conversion table, or by calculating the temperature using a fourth-order polynomial. When an embedded loop is used to heat the pedestal, the heater control subroutine 387 gradually controls a ramp up/down of current applied to the loop. Additionally, a built-in fail-safe mode can be included to detect process safety compliance, and can shut down operation of the heating unit if the process chamber is not properly set up. The temperature of the substrate may be modified during the process in accordance with instructions received from the trained evaluation system 216.

The plasma control subroutine 390 comprises program code for setting the low and high frequency RF power levels applied to the process electrodes in the chamber and for setting the low frequency RF frequency employed. Similar to the previously described chamber component subroutines, the plasma control subroutine 390 is invoked by the chamber manager subroutine 377a and its operation may be modified during the process in accordance with instructions from the trained evaluation system 216.

The above reactor description is mainly for illustrative purposes, and the methods of the present invention are not limited to any specific apparatus or to any specific plasma excitation method.

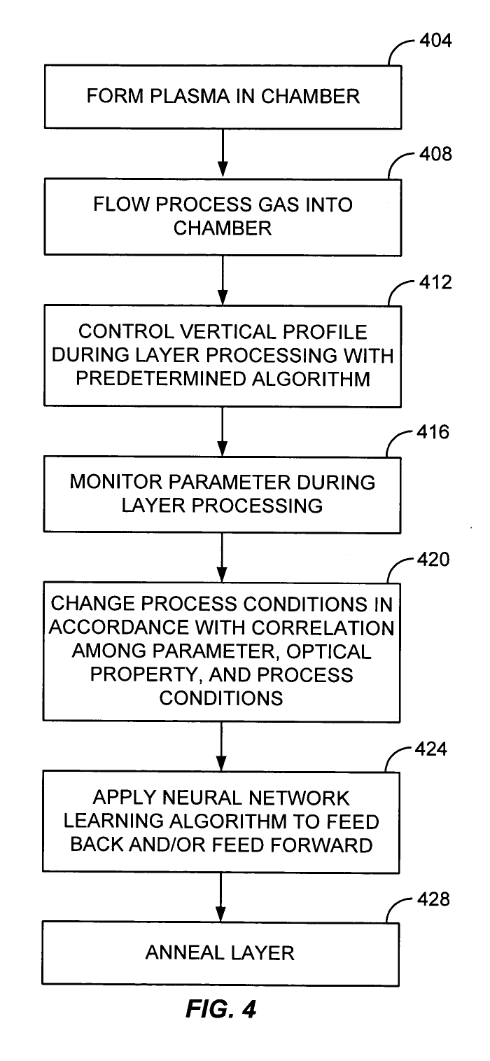

The above overview of how the program code implements processing of films in accordance with embodiments of the invention is summarized with the flow diagram provided in FIG. 4. At block 404, a plasma is formed in a process chamber and at block 408, process gas is flowed into the chamber. The vertical profile of the film is controlled during processing with a predetermined algorithm, as indicated at block 412. At block 416, a parameter is monitored during film processing, such as process parameter or film-property parameter. For example, such a parameter may be monitored by using reflectometry and/or ellipsometry measurements, among others described more fully above. The process conditions may be changed at block 420 in accordance with a correlation among the parameter, a desired optical property for the film, and the existing process conditions. Identification of such a correlation may be effected, for example, as indicated at block 424 by applying a neural-network-based learning algorithm to provide feedback and/or feed-forward information. Once formed, the film may be annealed at block 428, usually at a temperature of 800-1100° C.

Such a neural-network-based algorithm may use a pattern-recognition algorithm to identify which values of the process conditions may be most effectively manipulated to achieve the desired properties of deposited films. In a specific implementation of the pattern-recognition algorithm, reliability is thus ensured by training the evaluation system 220 with a set of certifiable data that accounts for different factors that bear on the properties of the deposited films as defined by specific measurable parameters. Some examples of these data are discussed specifically below. In particular, a variety of sample process conditions are used to determine the effect on film properties, such as on optical film properties, experimentally. The resulting correlations between the measurable parameters corresponding to the film properties and the process conditions are used to train the evaluation system 220. The results are stored in the knowledge database 224 for use when the evaluation system is presented 220 with new data. The ability to interpolate among known values, and to modify the knowledge database 224 with new results, permits the evaluation system 220 to determine appropriate process conditions reliably and to be self-correcting as new data are accumulated.

The neural network acts in an adaptive manner. For example, the network may instruct the chamber manager to alter process conditions in a certain manner with the expectation that a certain film property will result. If the film property is subsequently measured and found to differ from the expected property, such as by having too large a refractive index, this information may be fed back to the network, with the network then modifying itself so that over time it improves its accuracy in defining process conditions. Other types of trained evaluation systems may alternatively be used. For example, in one embodiment the trained evaluation system comprises an expert system. In other embodiments, still other artificial-intelligence systems known to those of skill in the art may be adapted to the functions described herein.

Exemplary Film Deposition Results

A number of experiments have been carried out to illustrate effects that may be used by the trained evaluation system. Results are presented specifically for experiments using deposition of undoped silicate glass (“USG”), and the inventors have verified that similar trends exist for the deposition of doped silicate glasses, including phosphosilicate glass (“PSG”) and borophosphosilicate glass (“BPSG”). In a specific embodiment set forth below, optical waveguides are formed using a combination of USG, PSG, and BPSG.

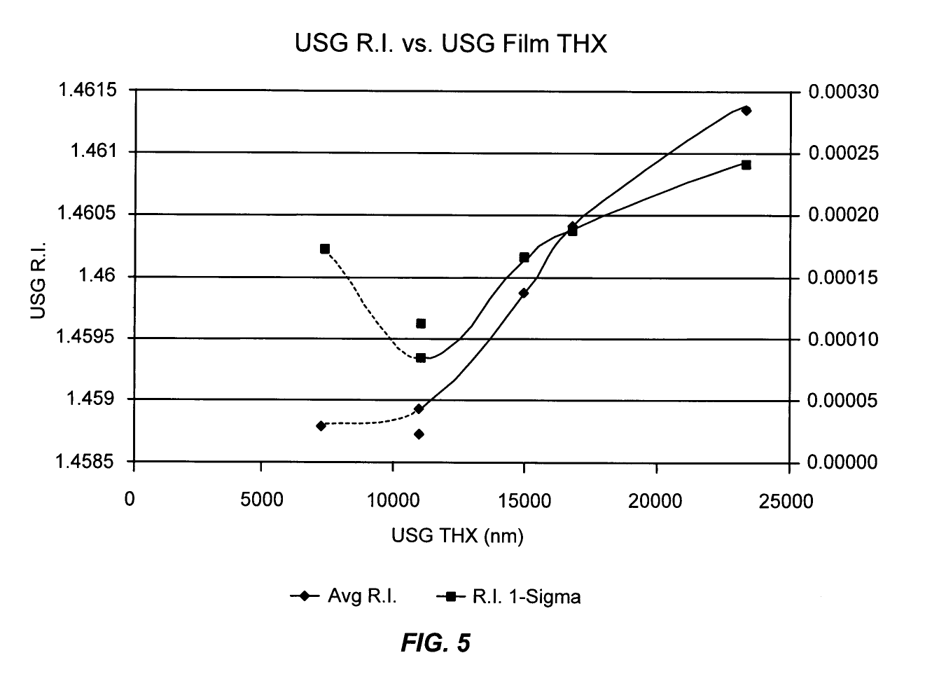

The experiments described in connection with FIGS. 5-7C were performed for the deposition of USG under similar conditions on 200-mm silicon wafers. Precursor gases of SiH₄ and N₂O were supplied to the process chamber at substantially the same flow rates under identical source power, pressure, and substrate-temperature conditions. In each of the experiments, several runs were performed for different deposition times, and properties of the deposited films were measured.

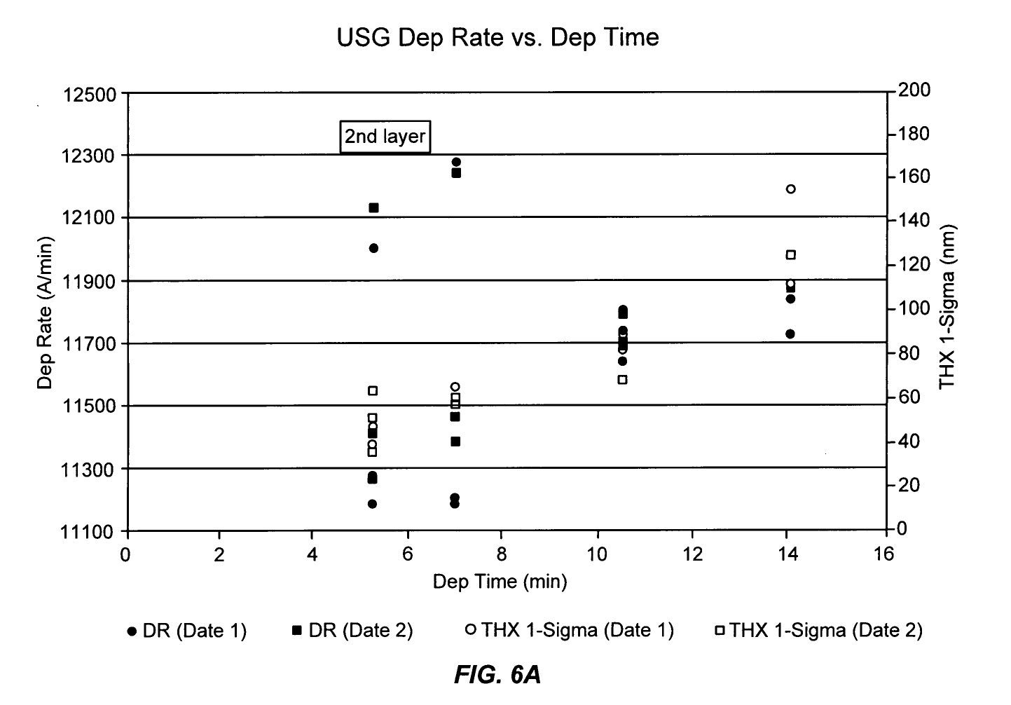

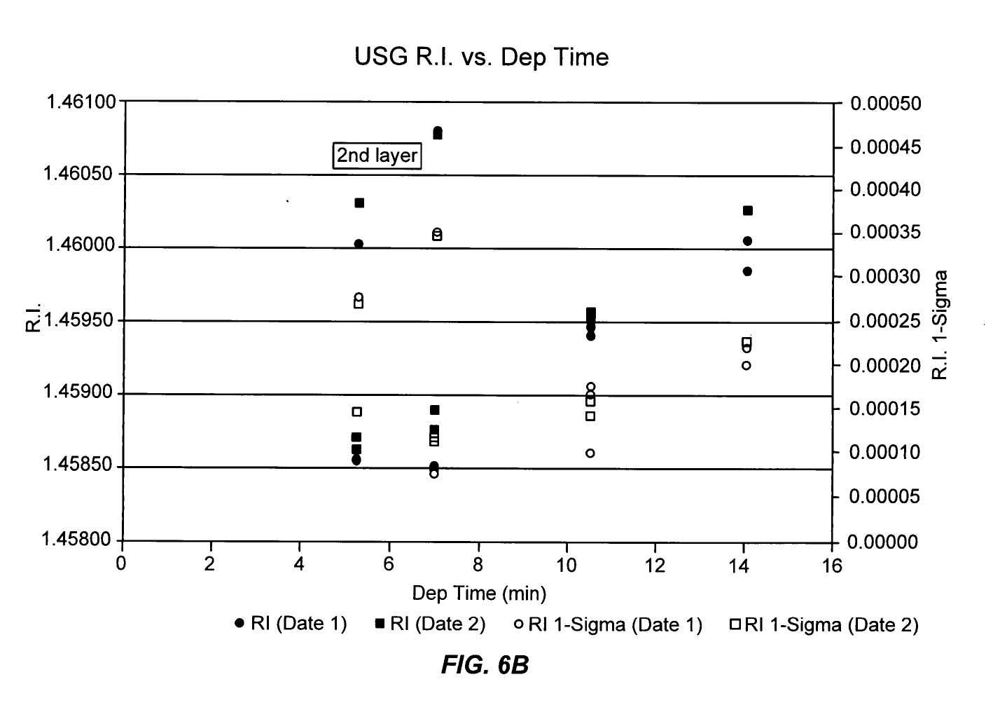

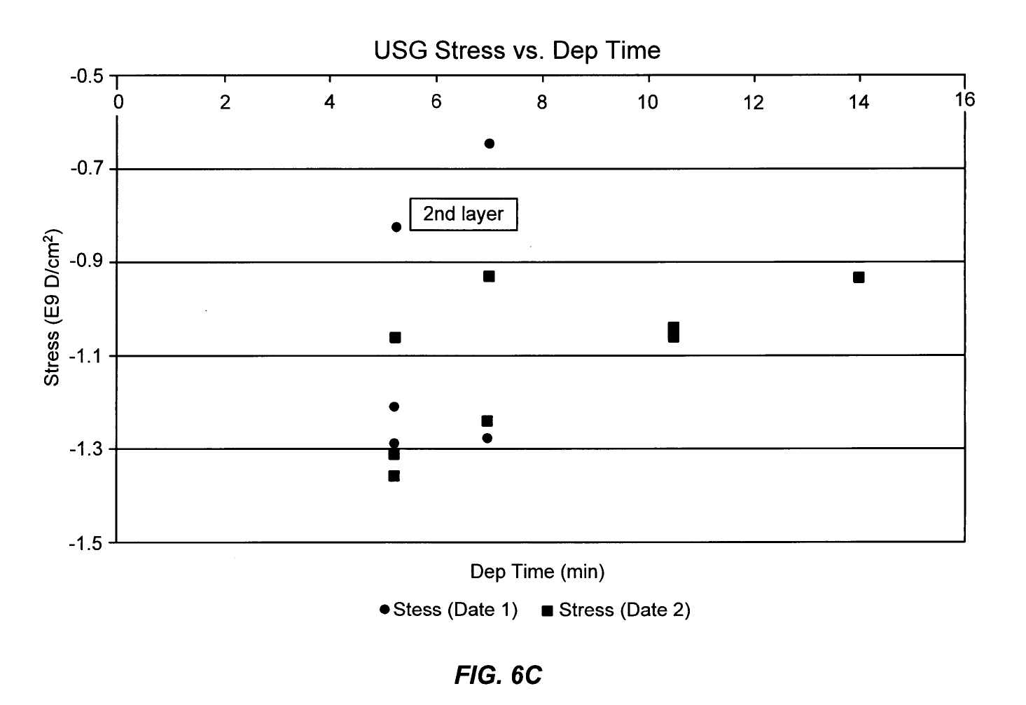

The results of FIG. 5 and FIGS. 6A-6C illustrate trends that are manifested for the refractive index, deposition rate, and stress of deposited films when the deposition conditions are static. These results demonstrate that under actual process conditions, there is an intricate interplay between process conditions, measured parameters, and optical properties of films. The data shown in FIG. 5 summarize a collection of results and were produced by measuring the refractive index of USG films having thicknesses between 7500 nm and 23,000 nm. The refractive indices were determine with a monitoring device that provided reflectometry data and the thicknesses were determined with a monitoring device that provided ellipsometry data. Both the mean refractive index value (diamonds) and one-σ standard-deviation values (squares) are plotted. The left ordinate indicates the absolute value of the measurements and the right ordinate indicates the relative change from a reference value of RI=1.4585. As can be seen, the refractive index shows a generally increasing trend with film thickness. The size of the increase is approximately ΔRI=0.0025 over more than a 15,000-nm increase in thickness. In the context of electronics applications, such a variation in refractive index would be more than acceptable, but may have a detrimental impact on performance in optical applications. More precise control over the refractive index than is afforded by static deposition parameters is provided with the trained evaluation system in embodiments of the invention.

FIGS. 6A-6C provide individual results for the deposition rate, refractive index, and stress as a function of deposition time. The data were collected on two different dates, identified as “Date 1” and “Date 2,” with the “Date 1” results being shown in all three graphs using circles and the “Date 2” results being shown in all three graphs using squares. In all cases, the data are shown using solid symbols, and for deposition-rate and refractive-index results shown in FIGS. 6A and 6B, one-σ standard deviation results are shown with open symbols. Such one-σ results are provided directly for the refractive-index results of FIG. 6B, but are correlated with deviations in film thickness for the deposition-rate results of FIG. 6A. In addition, all of the results include some data labeled “2nd film.” These data correspond to a second film formed over the first film after deposition of the first film is completed; in a sense, therefore, the deposition of the second film may be considered to be an extension of the deposition of the first film, and this is reflected in the data.

The results of FIGS. 6A, 6B, and 6C are examples of data that are provided to train the evaluation system in correlating conditions with film properties. These data show clear trends of increasing deposition rate, increasing refractive index, and decreasing compressive stress as the thickness of the deposited film increases. These variation trends may be explained as deriving from a reduction in the effective plasma RF power as the film grows during deposition. Accordingly, once the evaluation system is trained, it responds by varying the process conditions during deposition to account for the effect. In one embodiment, the trained evaluation system implements a power-stepping procedure during deposition so that the plasma RF power increases to account for its effective reduction during film growth. Such power stepping may be performed discretely or may be performed continuously, and the results shown herein demonstrate the effectiveness of the control mechanisms described herein. It will, of course, be appreciated that such power-stepping examples are merely illustrative and that many other diverse types of changes in process parameters may be used in other embodiments.

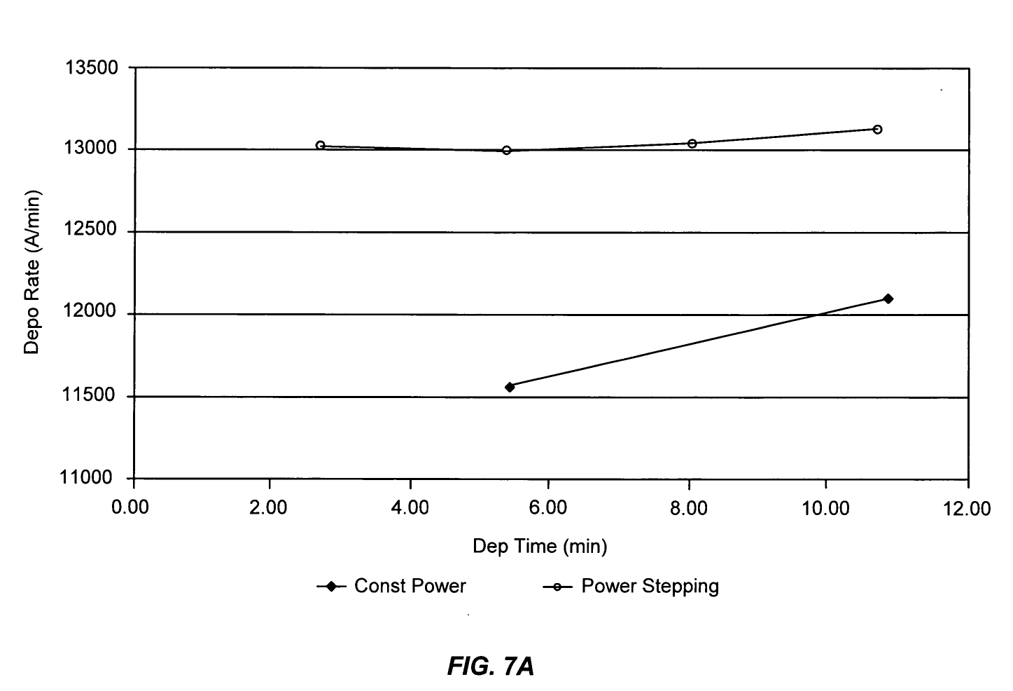

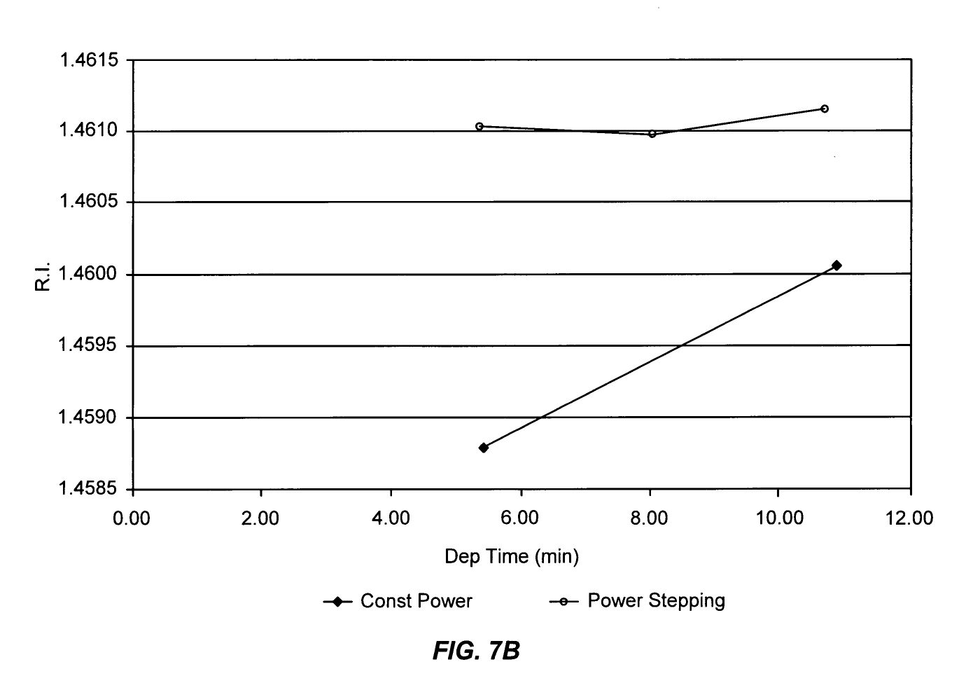

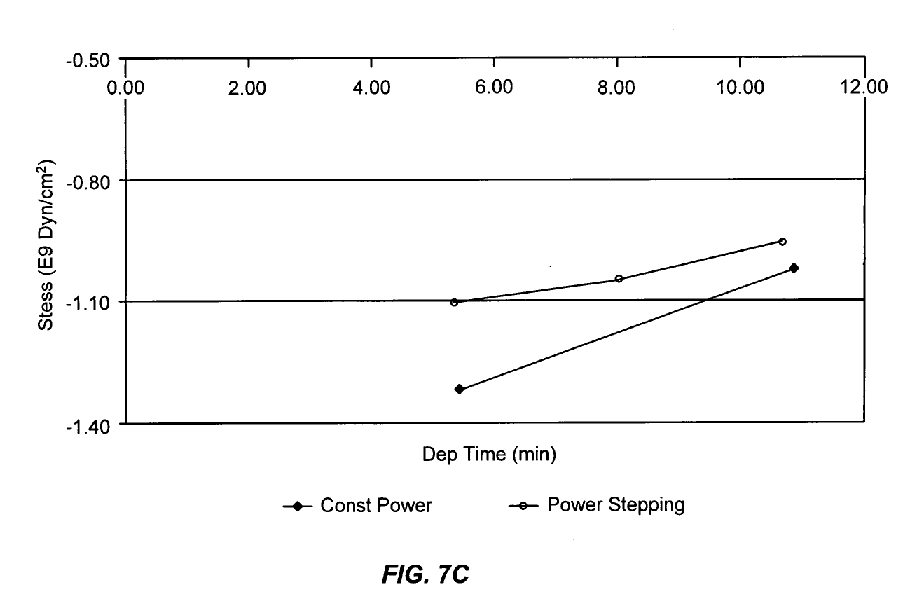

The success of implementing the power stepping is illustrated with the results provided in FIGS. 7A-7C for different parameters. These results are presented as counterparts to the results shown for static process conditions in FIGS. 6A-6C, with FIG. 7A showing results for deposition rate as a function of deposition time, FIG. 7B showing results for refractive index as a function of deposition time, and FIG. 7C showing results for the stress as a function of deposition time. The deposition rate is an example of a process parameter and the refractive index is an example of a film-property parameter. In each of the graphs, solid diamonds are used to show results from depositions using static process conditions for comparison, and open circles to show results from depositions that use discrete power stepping. Four steps were used for the RF power level, corresponding to (P₀−5%), P₀, (P₀+5%), and (P₀+10%), where P₀ is the static RF power level used in producing the results of FIGS. 6A-6C. The power was stepped at fixed intervals of 160 seconds.

As shown in FIG. 7A, such a power stepping results in an approximately constant deposition rate of about 13,000 Å/min. The constancy is particularly notable when compared with the increasing deposition rate that results when static process conditions are used. FIG. 7B shows additionally that the refractive index of the deposited film may be constrained much more tightly with the power stepping than with static process conditions. For example, FIG. 7B shows a variation in refractive index of about 0.0013 for static process conditions, but a variation less than 0.0003 when the power stepping is used. Also, the variation in stress is reduced when power stepping is used, as shown in the comparison with results from static process conditions in FIG. 7C.

The results in FIGS. 7A-7C show generally that beneficial changes in process conditions may be effected directly from the type of training information drawn from the data in FIGS. 6A-6C. Even tighter control may be placed on the parameters by continuously adjusting the RF power level rather than using discrete stepping. Also, the control may be made tighter by using the feedback provided by the trained evaluation system with respect to other process conditions, such as substrate temperature, precursor flow levels, pressure, etc. Furthermore, training may be performed so that other parameters are monitored and used for changing the process conditions. This may include process parameters, such as those provided by plasma diagnostics, and may include other film-property parameters in addition to refractive index.

Also, while the results in FIGS. 7A-7C have been presented to illustrate maintaining a constant value of a parameter, in alternative embodiments the process conditions are controlled by the trained evaluation system to achieve a specifically desired variation in the parameter through the film. For example, in many optical-waveguide applications, both refractive index of the core RI_{core} and the refractive index of the cladding layers RI_{clad} are preferably constant, with RI_{clad}<RI_{core}. Such optical waveguides are commonly referred to as “step-index” waveguides. In other applications, however, it is desirable to form a “graded-index” waveguide in which the refractive index of the core RI_{core} varies. In one application, the desired variation in refractive index for the core of radius r_{core} is specified approximately by the equation

$${RI}_{core} = {RI}_{core}^{( 0 )} \sqrt{1 - 2 \frac{{RI}_{core}^{( 0 )} - {RI}_{clad}}{{RI}_{clad}} {( r / {r}_{core} )}^{2}}$$

as a function of the radius r through the core. Such a specific graded-index variation in the waveguide may be achieved with the feedback provided in embodiments of the invention and cannot easily be realized with static process conditions.

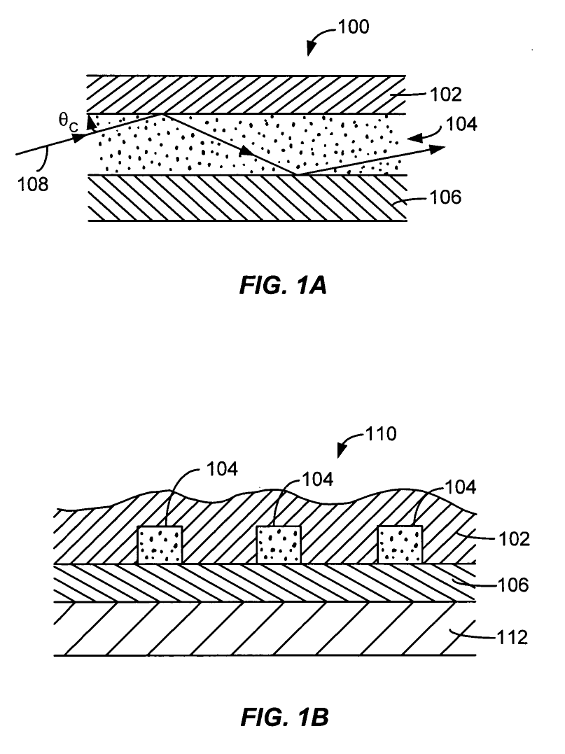

In a specific embodiment, the methods and systems of the invention are used to form an optical waveguide having the structure shown in FIG. 1B. The undercladding layer 106 comprises a USG film formed over a silicon substrate 112 with SiH₄ and N₂O as precursor gases. The cores 104 comprise PSG formed with SiH₄, N₂O, and PH₃ precursor gases. The uppercladding layer 102 comprises BPSG formed with SiH₄, N₂O, and PH₃, and B₂H₆ precursor gases. Each of the undercladding layer, cores, and uppercladding layers have narrowly limited refractive indices established by use of the trained evaluation system. Typical thicknesses are about 15 μm for the USG undercladding layer, about 7 μm for the PSG cores, and about 15 μm for the BPSG uppercladding layer.

After reading the above description, other variations will be apparent to those of skill in the art without departing from the spirit of the invention. For example, while the invention has been described in detail for a plasma deposition process, the principles of the invention may also be used in other nonplasma deposition processes such as MOCVD processes. Also, while the description has focussed on deposition of silicon-containing thick films, the methods and systems of the invention may also be used for deposition of non-silicon-containing thick films, such as III-V and/or II-VI semiconductor thick films. These equivalents and alternatives are intended to be included within the scope of the present invention. Therefore, the scope of this invention should not be limited to the embodiments described, but should instead be defined by the following claims.

1. A method for processing a film over a substrate in a process chamber, the method comprising:
flowing a process gas suitable for processing the film over the substrate into the process chamber in accordance with a predetermined algorithm specifying process conditions;
monitoring a parameter during processing of the film over a thickness greater than 3 μm; and
changing the process conditions in accordance with a correlation among a value of the parameter, an optical property of the film, and the process conditions.

2. The method recited in claim 1 further comprising forming a plasma in the process chamber from the process gas.

3. The method recited in claim 1 wherein monitoring the parameter comprises monitoring the parameter during processing of the film over a thickness greater than 5 μm.

4. The method recited in claim 1 wherein the predetermined algorithm is optimized to control a vertical profile of the film.

5. The method recited in claim 1 wherein the predetermined algorithm is optimized to control a horizontal profile of the film.

6. The method recited in claim 1 wherein changing the process conditions is performed in response to a change in the parameter.

7. The method recited in claim 1 wherein the parameter comprises a process parameter.

8. The method recited in claim 1 wherein the parameter comprises a film-property parameter.

9. The method recited in claim 8 wherein the parameter comprises a reflectometry measurement.

10. The method recited in claim 8 wherein the parameter comprises an ellipsometry measurement.

11. The method recited in claim 1 wherein the parameter comprises a stress uniformity of the film.

12. The method recited in claim 1 wherein changing the process conditions is performed by a trained evaluation system.

13. The method recited in claim 12 wherein the trained evaluation system comprises an expert system.

14. The method recited in claim 12 wherein the trained evaluation system comprises a neural network.

15. The method recited in claim 1 wherein changing the process conditions is performed to maintain a substantially constant value for the optical property of the film throughout processing the film.

16. The method recited in claim 1 wherein changing the process conditions is performed to deposit the film with a desired variation in the optical property of the film throughout processing the film.

17. The method recited in claim 1 wherein the process gas comprises a silicon-containing gas and an oxygen-containing gas.

18. The method recited in claim 1 wherein processing the film comprises depositing the film.

19. The method recited in claim 1 wherein processing the film comprises etching the film.

20. The method recited in claim 1 further comprising annealing the film.

21. A method for forming an optical waveguide over a substrate in a process chamber, the method comprising:
forming a plasma in the process chamber;
flowing a silicon-containing gas and an oxygen-containing gas into the process chamber in accordance with a predetermined algorithm specifying process conditions to deposit a film over the substrate;
monitoring a refractive-index value of the film during deposition of the film over a thickness greater than 3 μm; and
changing the process conditions in accordance with a correlation between the refractive-index value and the process conditions.

22. The method recited in claim 21 wherein monitoring the refractive-index value comprises monitoring the refractive-index value of the film during deposition of the film over a thickness greater than 5 μm.

23. The method recited in claim 21 wherein the predetermined algorithm is optimized to control a vertical profile of the film.

24. The method recited in claim 21 wherein the predetermined algorithm is optimized to control a horizontal profile of the film.

25. The method recited in claim 21 wherein changing the process conditions is performed by a trained evaluation system.

26. The method recited in claim 25 wherein the trained evaluation system comprises an expert system.

27. The method recited in claim 25 wherein the trained evaluation system comprises a neural network.

28. The method recited in claim 21 wherein changing the process conditions is performed to maintain a substantially constant value for the refractive-index value throughout the deposition.

29. The method recited in claim 21 wherein changing the process conditions is performed to deposit the film with a desired variation in the refractive-index value throughout the deposition.

30. The method recited in claim 21 wherein changing the process conditions comprises increasing an RF source power for maintaining the plasma.

31. The method recited in claim 30 wherein the RF source power is increased discretely.

32. The method recited in claim 30 wherein the RF source power is increased continuously.

33. The method recited in claim 21 further comprising annealing the film.

34. A thick-film processing system comprising:
a housing defining a process chamber;
a plasma-generating system operatively coupled to the process chamber;
a substrate holder configured to hold a substrate during substrate processing;
a gas-delivery system configured to introduce gases into the process chamber;
a pressure-control system for maintaining a selected pressure within the process chamber;
a sensor disposed to monitor a parameter during processing within the process chamber;
a controller for controlling the plasma-generating system, the gas-delivery system, the sensor, and the pressure-control system; and
a memory coupled with the controller, the memory comprising a computer-readable medium having a computer-readable program embodied therein for directing operation of the thick-film processing system, the computer-readable program including:
instructions to control the plasma-generating system to form a plasma in the process chamber;
instructions to control the gas-delivery system to flow a process gas suitable for depositing the film over the substrate in accordance with a predetermined algorithm specifying process conditions;
instructions to control the sensor to monitor the parameter during processing of the film over a thickness greater than 3 μm; and
instructions to change the process conditions in accordance with a correlation among a value of the parameter, an optical property of the film, and the process conditions.

35. The thick-film processing system recited in claim 34 wherein the instructions for monitoring the parameter comprise instructions for monitoring the parameter over a thickness greater than 5 μm.

36. The thick-film processing system recited in claim 34 wherein the predetermined algorithm is optimized to control a vertical profile of the film.

37. The thick-film processing system recited in claim 34 wherein the predetermined algorithm is optimized to control a horizontal profile of the film.

38. The thick-film processing system recited in claim 34 wherein the instructions to change the process conditions are executed in response to a change in the parameter.

39. The thick-film processing system recited in claim 34 wherein the sensor comprises a reflectometer.

40. The thick-film processing system recited in claim 34 wherein the sensor comprises an ellipsometer.

41. The thick-film processing system recited in claim 34 wherein the sensor is configured to measure a stress of the film.

42. The thick-film processing system recited in claim 34 wherein the instructions for changing the process conditions are executed to maintain a substantially constant value for the optical property of the film throughout depositing the film.

43. The thick-film processing system recited in claim 34 wherein the instructions for changing the process conditions are executed to deposit the film with a desired variation in the optical property of the film.
